(19) United States
(12) Patent Application Publication
(10) Pub. No.: US 2013/0119734 A1
(43) Pub. Date: May 16, 2013

(54) SELF LOCKING MODULAR ARTICULATED FRAME

(71) Applicant: Steven Corcoran, Cawood (GB)

(72) Inventor: Steven Corcoran, Cawood (GB)

(21) Appl. No.: 13/640,171

(22) PCT Filed: Aug. 12, 2010
(86) PCT No.: PCT/GB10/01541

§ 371 Date: Feb. 1, 2013

(30) Foreign Application Priority Data
Apr. 6, 2010 (GB) 1005693.5

(51) Int. Cl. A47C 1/024; A47C 1/029; A61G 5/14

(52) U.S. Cl. CPC A47C 1/024; A61G 5/14; A47C 1/029
USPC 297/330; 297/313

(57) ABSTRACT

An articulating frame comprising parallel aligned base frame elements (2A, 2B) in a first plane adjustably connected to parallel aligned upper frame elements (4A, 4B) in a second plane, parallel to the first plane, the adjustable connection between any pair of connected base frame (2A, 2B) and upper frame (4A, 4B) elements comprising one or more knuckles (10A, 10B, 10C, 10D) each knuckle being capable of a combination of rotational and linear movement and operable independently of the others to provide both linear and rotational repositioning of a frame element (2A, 2B; 4A, 4B) relative to the other of the connected pair at the point of connection.

The present invention relates to adjustable frames used for example, in adjustable chairs. More particularly, the invention provides an articulated frame which can for example (but without limitation) be used as a frame for a chair which is height adjustable and tiltable about multiple axes.

The need for articulating chair frames is widely known however the ability to separate the articulation of the frame from the articulation of other chair components such as the backrest, seat and leg rest whilst achieving high functionality and manoeuvrability of the frame has not hitherto been achieved. The articulation of the frame of a chair typically seeks to address criteria such as occupant comfort, convenient occupant sit/stand assistance, and a range of position adjustment to suit an individual user's needs.

The prior art centres on chair frames configured to provide occupant comfort and to assist in the sit/stand cycle. In the prior art, all sections of the chair (backrest, seat and frame) are configured to move in unison. Chair sections are not adjustable independently of the frame. As such the prior art fails to yield high functionality or the ability to tailor to an individual's requirements (including degree of sit/stand assistance). One particular problem with regards to sit/stand assistance provided by prior art chairs relies heavily on the backrest moving with the frame to push the occupant forward. In such prior art arrangements, movement of the cumbersome backrest can be obstructed by walls or ceilings.

An example of the described prior art is U.S. Pat. No. 5,061,010 of Lapointe.

The present invention seeks to provide a modular articulated frame which provides greater manoeuvrability and range of adjustments of seats compared to the prior art.

In accordance with the present invention there is provided an articulating frame comprising parallel aligned base frame elements in a first plane adjustably connected to parallel aligned upper frame elements in a second plane, parallel to the first plane, the adjustable connection between any pair of connected base frame and upper frame elements comprising one or more knuckles each knuckle being capable of a combination of rotational and linear movement and operable independently of the others to provide both linear and rotational repositioning of a frame element relative to the other of the connected pair at the point of connection.

Desirably, the knuckle is serially linked to a linear actuator capable independently of adjusting the separation of the connected pair of frame elements. The linkage between the knuckle and linear actuator may comprise a multi axis joint. For example the joint incorporates is a rose type bearing.

In a preferred embodiment, a knuckle comprises; a rotary actuator arranged to rotate a leadscrew, an internally threaded saddle meshing with the leadscrew and having a toothed section meshing with a first gear mounted on a first shaft aligned orthogonally to the leadscrew, a second gear mounted on a second shaft aligned in parallel with the first shaft, the second gear meshing with the first gear, a casing rotatably mounted relative to the axis of the second shaft, the casing enclosing a linear actuator, the arrangement being configured such that on operation of the rotary actuator, the angular separation of the axis of the linear actuator relative to a plane which includes the axes of both the first and second shaft is adjusted.

Desirably, an end of the casing distal to the shafts is provided with an attachment means for attaching to other components. Optionally, the attachment means comprises a multi-axis bearing, for example (but without limitation) a rose type bearing.

The Applicant's novel knuckle arrangement is subsequently referred to herein as the “super knuckle”.

The linear actuators of the frame and super knuckle may optionally have the following configuration; a motor configured to drive a first gear in two opposite directions which first gear in turn meshes with a second gear, the second gear operably coupled to a leadscrew such that rotation of the first gear results in rotation of the leadscrew in a direction determined by the direction of rotation of the first gear, the leadscrew rotatably mounted in a fixed axial orientation, a piston which is internally threaded and slidably engages the leadscrew thread and means for restricting rotational movement of the piston about the leadscrew axis whereby to force the piston to travel linearly along the axis of the leadscrew when the leadscrew rotates, the linear travel being in either of two opposite directions determined by the direction of rotation of the leadscrew.

Conveniently the means for restricting rotational movement comprises a cylindrical sleeve sharing a common axis with the leadscrew and piston and maintained in a fixed rotational position with respect to the axis, the piston including one or more radially outwardly extending protrusions which engage in a longitudinal slot provided in the cylindrical sleeve.

Desirably, an end of the piston distal to the second gear is provided with an attachment means for attaching to other components. Optionally, the attachment means comprises a multi-axis bearing, for example (but without limitation) a rose type bearing.

The shafts of the super knuckle can extend beyond the knuckle to incorporate additional shaft mounted gears, these shaft mounted gears can be operably connected to other gear driven components in the frame to facilitate combined movements and/or the use of a shared gear box to drive the components.

Optionally the frame includes a length change mechanism configured for adjusting the separation between elements along an axis substantially perpendicular to the first and second frame. In one suitable embodiment, the mechanism comprises a length change transmission including a first bevel gear attached to or integral with a first section of a split hollow shaft, a second section of the split hollow shaft terminating in a second bevel gear, the split hollow shaft incorporating a longitudinal slot in parallel with the axis of the shaft, a central shaft slidably mounted inside the hollow split shaft sharing the axis of the split shaft the central shaft having one or more radially outwardly extending protrusions which engage in the slot.

Conveniently the slot extends through to the opposite side of the split hollow shaft and the central shaft includes protrusions engaging with the slot on both sides of the axis. In a frame assembly, the bevelled gears operably connect a drive means to a lifting mechanism which lifting mechanism may comprise the one or more linear actuators previously described. The drive means may, for example comprise a gear which can be manually operated by applying leverage to an associated handle. Alternatively, rotation of the gear may be achieved through electrical means, eg. a button activated motor.

The length change mechanism is conveniently operably coupled to a cross bar by means of which adjustment of the separation can be enabled.

A suitable embodiment of a cross bar encapsulates a linear actuator having a casing containing a motor configured to rotate in two opposite directions and operably connected to a leadscrew, the leadscrew threaded section meshed with an internal thread of a piston the piston being constrained from rotating with the leadscrew but free to move linearly along the leadscrew axis in either of two opposite directions dictated by the direction of rotation of the motor.

The bar conveniently terminates in a connecting component for connecting to a frame element in each of the first and second planes. On actuation of the motor of the cross bar, the separation of the planes containing the frame elements is adjusted. Since the central shaft of the length change mechanism is slidably engaged in the split hollow shaft, the length of that is also adjusted.

Optionally, the base frame elements incorporate additional height adjustment mechanisms in use, located between the base frame and a surface on which the base frame rests. In addition or in an alternative, the base frame elements may incorporate a castor. The castor desirably incorporates a lock to prevent unwanted rolling.

In the seat frame embodiments contemplated, the present invention achieves extensive manoeuvrability and provides a seat that centres and attains occupant comfort, occupant sit stand assistance and the ability to tailor to the individual's needs whilst establishing modularity. Modularity facilitates easier repair and maintenance of the chair and enables bespoke chairs to be conveniently assembled to suit the specific requirements of a given user.

Other practical applications of the frame include; hoists, diggers, trailers, tow bars, couplings, cherry pickers, conveyors, gaming platforms, pallets, fork lift trucks and similar lifting and moving devices which usefully employ both rotational and linear movements in combination.

By way of example, some embodiments of the invention and novel components for use therein are now described with reference to the accompanying Figures in which;

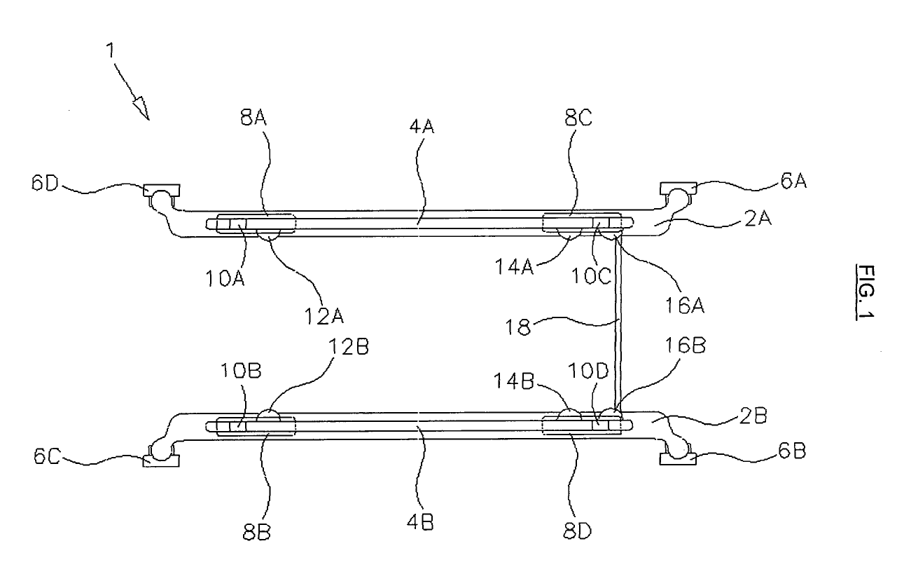

FIG. 1; a plan view of a first embodiment of an articulating frame in accordance with the invention

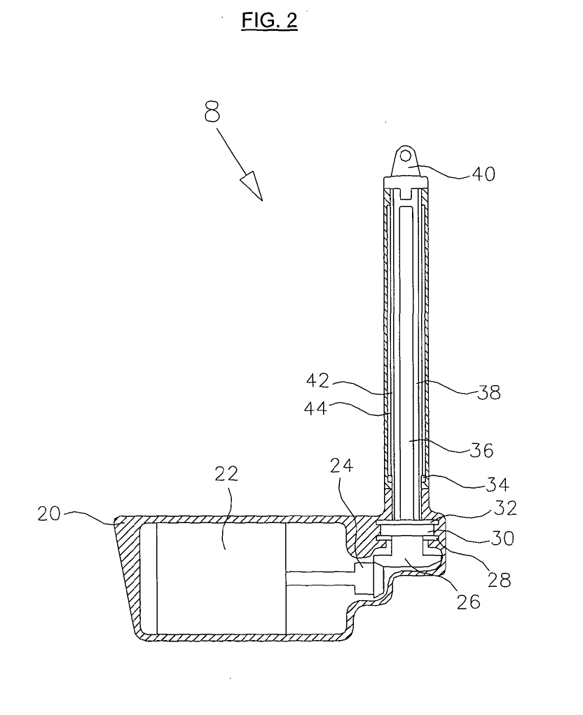

FIG. 2; a side sectional view of a linear actuator suitable for use in articulating frame in accordance with the invention

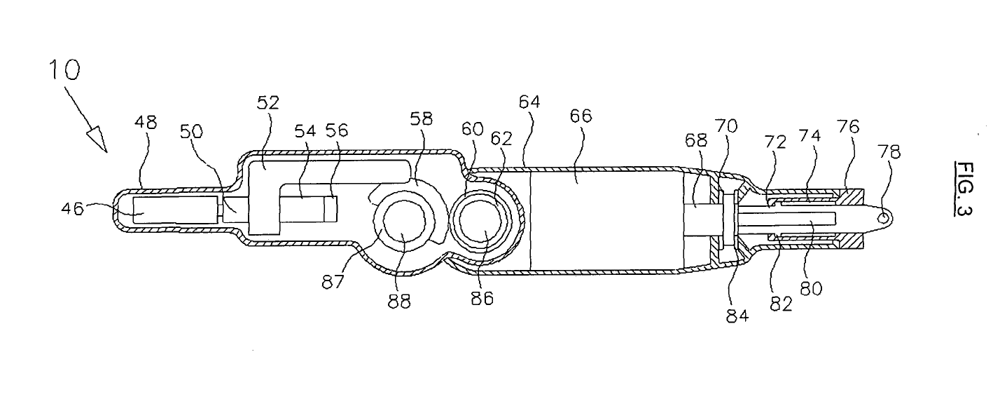

FIG. 3; a side view of a super knuckle suitable for use in articulating frame in accordance with the invention

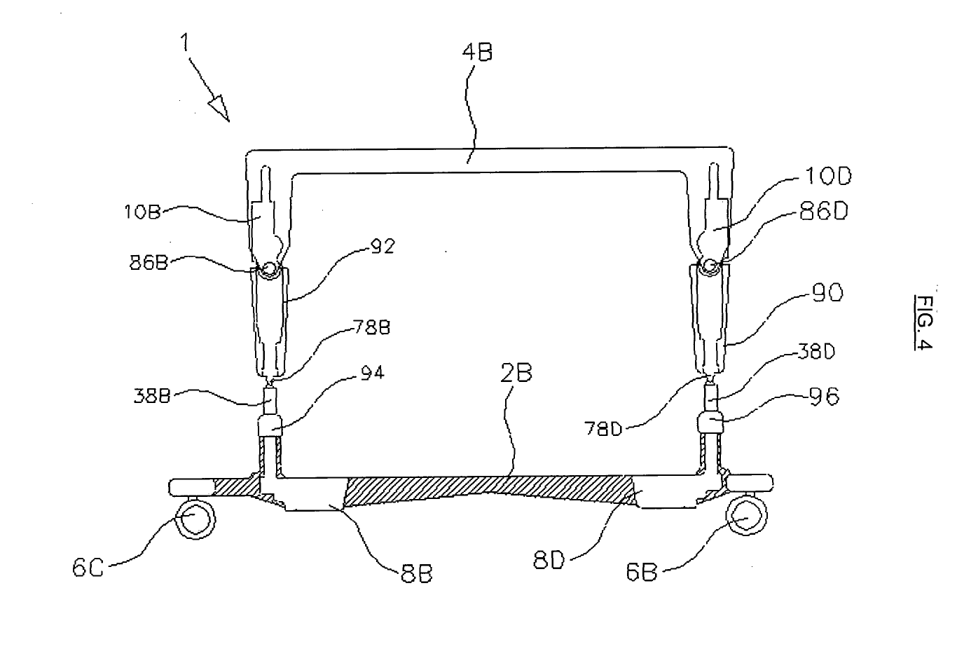

FIG. 4; a side view of the first embodiment

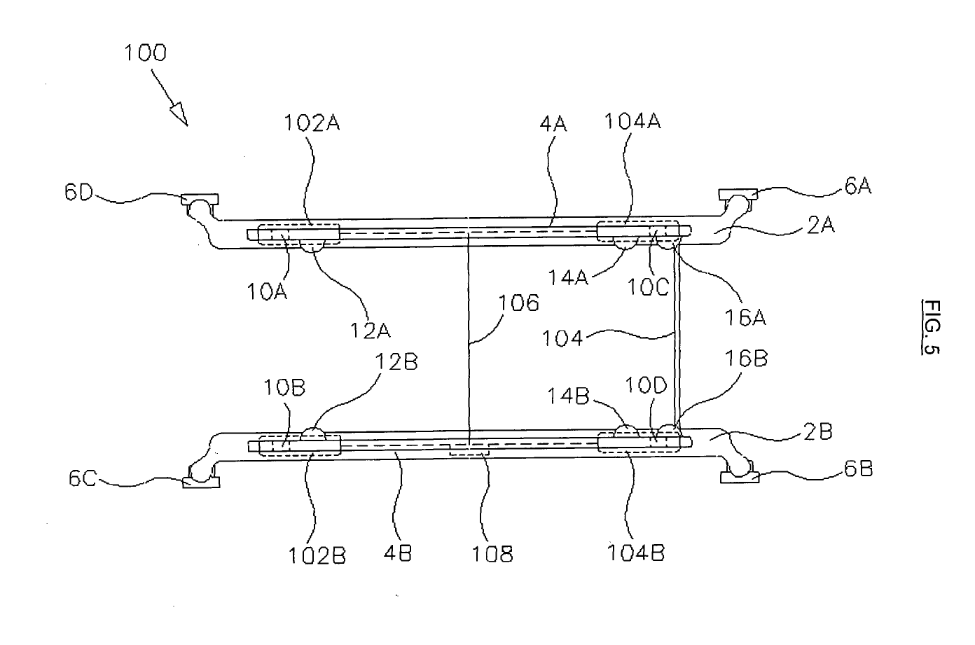

FIG. 5; a plan view of a second embodiment of an articulating frame in accordance with the invention

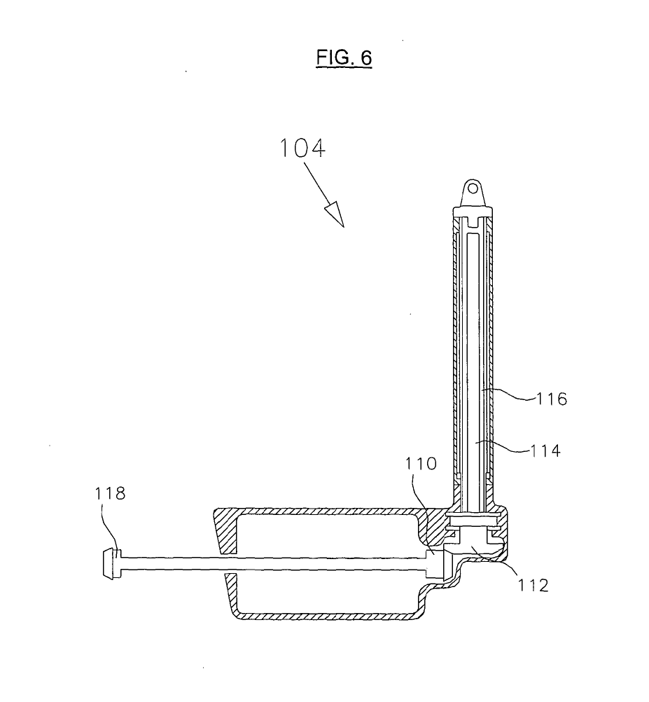

FIG. 6; a side view of a manual actuator of the second embodiment

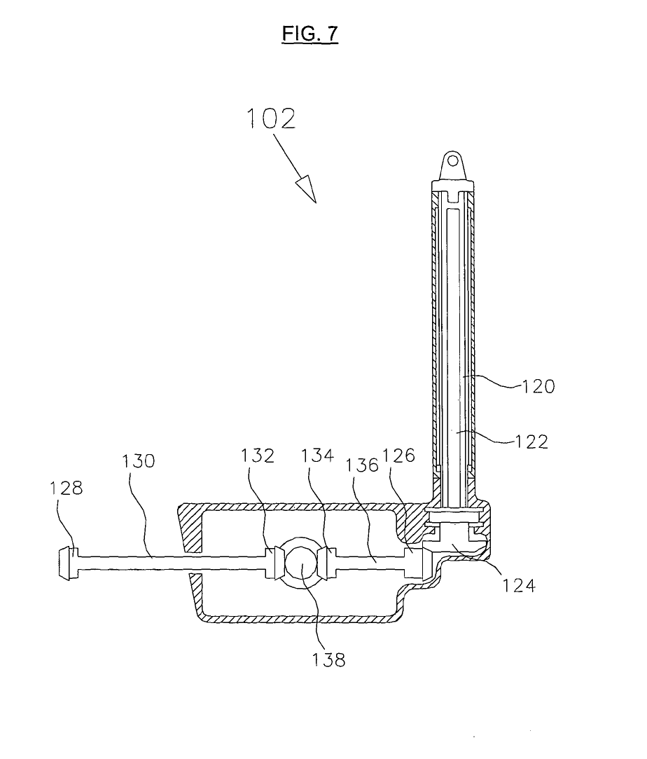

FIG. 7; a side view of a manual actuator of the second embodiment

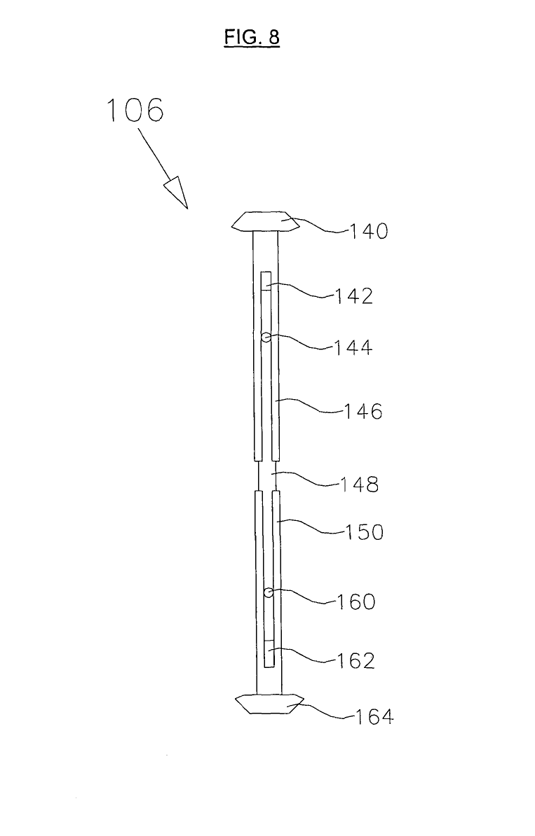

FIG. 8; a plan view of a transmission of the second embodiment

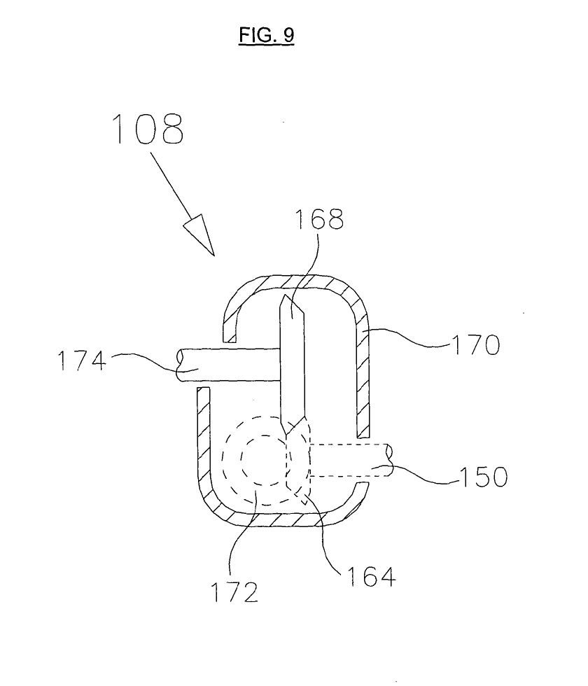

FIG. 9; a section view of a gearbox of the second embodiment

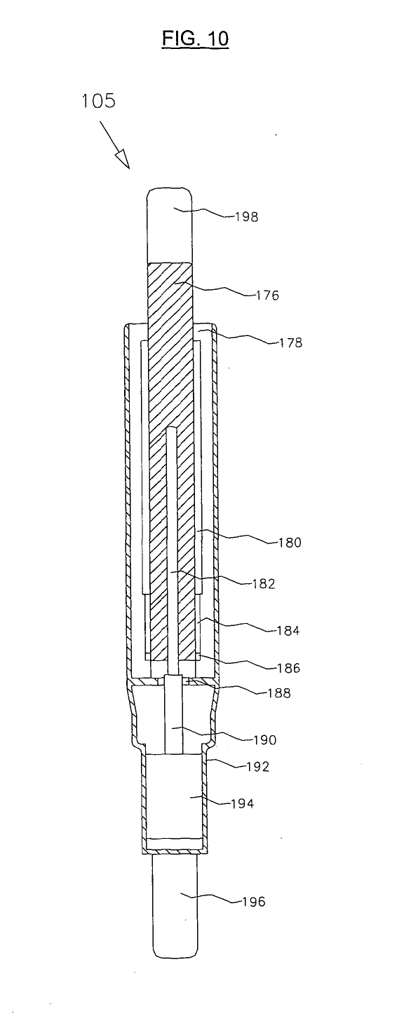

FIG. 10; a partial section view of a linear actuator of the second embodiment

### DESCRIPTION

The first embodiment 1 is illustrated in FIG. 1. The frame is symmetrical on both sides with two base frame units 2A and 2B. The base frame units are able to directly contact the ground or as shown here are able to include wheels 6A, 6B, 6C and 6D. The upper frame 4A and 4B is connected to the base 2A and 2B respective via the linear actuator modules 8A, 8B 8C and 8D.

The upper frame houses the super knuckles 10A, 10B, 10C and 10D and the upper frame 4A, 4B also features backrest connections 12A and 12B as well as seat connections 14A and 14B and leg rest connections 16A and 16B. All the connections are able to allow power and data to flow to and from the connected components such as a backrest, leg rest and seat. Connecting the frames is the connection bar 18 which is permanently or removably attached to base 2A and 2B or integrated with 2A and or 2B. Like the connections, the bar 18 is able to allow power and data to flow to and from the connected components such as a backrest, leg rest and seat and between the base and upper frames 2A, 2B and 4A and 4B respectively.

It will be appreciated that the wheels are able to be self propelling, self steering and feature brakes such that when any component above such as a super knuckle operates the brakes will automatically engage and all the wheels will be locked.

It will be appreciated that the connections 14A, 14B, 12A, 12B and 16A and 16B are able each to feature at least one linear and/or at least one rotary actuator which are able to be permanently or removably attached to or integrated with the upper frames 4A and 4B. More typically the at least one linear or rotary actuator is able to be encapsulated into the upper frame 4A, 4B. The linear and rotary actuators are able to be manual or electric and the rotary actuators are able to also be a gearbox.

FIG. 2 shows a linear actuator module 8 which is an example of a suitable linear actuator construction for the modules 8A, 8B, 8C and 8D of the first embodiment. The module 8 has a casing 20 which houses a motor 22 and includes an extended portion housing a piston 38. The motor 22 is typically an electric motor. The motor is permanently or removably attached to the gear 24 which is in turn meshed with the gear 26. The gear 26 is attached permanently or removably to or integrated with the leadscrew 36. The leadscrew 36 has a collar 30 which is held between two bearings 32 and 28 such that load from the leadscrew is transmitted to the casing 20.

The leadscrew 36 is meshed with a piston 38 which is internally threaded to slidably engage the leadscrew thread. The piston has an end 40. The end 40 is able to feature at least one bearing such as a rose type or other such multi axis bearing. The piston 38 features protrusions 34 which engage with longitudinally extending channels 44 of the extended casing 20 portion which encloses the piston 38. This prevents axial rotation of the piston 38 when the leadscrew 36 is rotated forcing axial movement of the piston 38. Within the casing 20, the piston is internally encased with a sleeve 42 which is held in place between an end cap and the bearing 32. The motor 22 is rotatable in two opposite directions. When the motor 22 rotates, gear 24 is rotated and in turn rotates gear 26 and the leadscrew 36. The leadscrew 36 via its meshed relationship with the piston 38 can advance or retract the piston 38 depending on the direction of rotation imparted by the motor 22.

It will be appreciated that the described arrangement is just one suitable embodiment of a linear actuator which may be used as the linear actuator modules 8A, 8B 8C and 8D. Alternative linear actuators are well known in the prior art and could be selected as an alternative without departing from the scope of the invention.

FIG. 3 shows a super knuckle 10 which is an example of a suitable super knuckle construction for the modules 10A, 10B, 10C and 10D of the embodiment of FIG. 1. The super knuckle 10 features a casing 48 which in the example shown houses a rotary actuator 46 which is able to be manually activated or electrically activated. In described example, actuator 46 is an electric motor. The electric motor 46 is permanently or removably attached to a leadscrew 54 which is housed in the casing by at least one bearing. In this case two bearings are utilised 50 and 56. The leadscrew 54 meshes with a saddle 52, the saddle 52 having a toothed section which in turn meshes with a gear 58.

The gear 58 is typically permanently or removably attached to a bearing 88 which is in turn permanently or removably attached to a shaft 87. The shaft 87 is permanently or removably attached to or integrated with the casing 48 and typically the shaft is fully integrated with the casing. The gear 58 is meshed with the gear 60 which is permanently or removably attached or integrated with the shaft 86 and typically the gear 60 is integral to the shaft 86. The shaft 86 exits the casing 48 whereby the shaft 86 passes through at least one bearing 62 and more typically two bearings, one located at each side of the gear 60. The at least one bearing 62 is held in the casing 48 and where the shaft exits the casing 48 it will be appreciated that the casing can also feature at least one sealing means.

In an alternative arrangement, the shaft 86 is also able to exit the casing 48 on just one side which features the sealing means, an end cap (which may be an integral part of the casing) retaining the enclosed end of the shaft 86 within the casing. The end cap and the exit from the casing both desirably include a bearing to allow free axial rotation of the shaft 86.

At the side, the shaft 86 is permanently or removably attached or integrated with a second casing 64. The casing 64 houses at least one component with relation to the linear actuation of a piston 72. In the example shown, the component is substantially similar to the linear actuator described in relation to FIG. 2. The casing 64 houses an actuator 66 which in this example is an electric motor. The electric motor is permanently or removably attached to a leadscrew which bears a threaded section 80. The leadscrew is borne by a joining section 68 featuring a collar which is rotatably mounted in the casing 48 by means of two bearings 70 and 84. The leadscrew meshes with the piston 72 which features at least one protrusion 82 which in turn engages in a channel 74 in an axially extending protrusion of the end cap 76. The piston features a joining element 78 which is able to be a multi-axis bearing, for example as a rose type bearing.

It will be appreciated that the super knuckle is capable of a combination of rotational and linear movement relative to axis of shaft 86 allowing both linear and rotational repositioning of two components connected by the super knuckle through one mechanism.

Rotational movement is achieved when the motor 46 is rotated in either one of two opposite directions. The motion rotates the leadscrew 54 which, via its meshed relationship with the saddle 52, adjust the linear position of the saddle 52 along the leadscrew axis. Assuming the shaft 86 to be held in a fixed position, the linear motion of the saddle rotates the gear 58 and via its meshed relationship with the gear 60 rotates the entire casing 48 about the axis of the gear 86 in one of two directions (determined by the direction of rotation of the motor 46).

Linear movement is achieved when the motor 66 rotates in either one of two opposite directions. Rotation in turn rotates the leadscrew and threaded section 80 via the joining section 68. As described in relation to the linear actuator of FIG. 2, rotational motion of the piston 72 is inhibited by engagement of the protrusions 82 in the channels 74, and so through the meshed relationship between the leadscrew threaded section 80 and the internally threaded piston 72, the piston is caused to move along the axis of the leadscrew in one of two directions determined by the direction of rotation of the motor 66.

It will be appreciated that the described arrangement is just one suitable embodiment of a super knuckle which may be used as the knuckle modules 10A, 10B, 10C and 10D. Alternative knuckles or linear and rotary actuator combinations are well known in the prior art and could be selected as an alternative without departing from the scope of the invention.

FIG. 4 shows a side view of the first embodiment 1. As has been described the frame is symmetrical and as such only one side of the frame will be described as both sides are the same. As will be appreciated, the above description has detailed the manner in which the various assemblies operate and thus will not be further described or repeated.

As can be seen from FIG. 4, the frame has an upper section 4B and a base section 2B. The base section contains two linear actuator modules 8B and 8D in the example shown (but not essentially) these modules are identical to the module 8 from FIG. 2. The linear modules are permanently or removably attached or integrated with the base 2B and as is shown are tapered and stepped to allow for ease of manufacturing assembly and stability. The modules 8B and 8D exit the base 2B via exit apertures 94 and 96 which desirably incorporate sealing means. The piston 38 (see FIG. 2) of the modules 8B and 8D feature and end cap 40 (see FIG. 2) with a multi-axis pivot connection which in turn is permanently or removably attached or integrated with the upper frame 4B with encased section 64 (see FIG. 3) enclosed in linear housing sections 92 and 90. The joining elements 78B and 78D of the enclosed linear section of the super knuckle 10B and 10D respectively are used to connect with the multi-axis pivot connection end caps 40 of the pistons of 38B, 38D of linear actuator modules 8B and 8D.

The super knuckles 10B and 10D are identical to the super knuckle 10 described in FIG. 3 as the joining elements 78B and 78D are identical to joining elements 78 of the piston 72 from the FIG. 3 and the pistons 38B and 38D are identical to the piston 38 from FIG. 2.

The rotary operating section of the super knuckles 10B and 10D encased in casing 48 (see FIG. 3) are permanently or removably attached to or integrated with the upper frame 4B. Rotation occurs about the axes of shafts 86B and 86D which are the same as the shaft 86 of the embodiment as shown in FIG. 3, where rotation is driven by rotation of the gear 58.

The base of the frame 28 may be placed directly on a surface such as a floor or in the alternative may feature one or more intermediate elements such as at least one linear actuator providing for height adjustment or in the case as shown, wheels. The wheels 6B and 6C are located front and rear of the frame and desirably feature automatic braking and/or a self propelling function and powered steering function. It will be appreciated that where the intermediate elements are linear actuators, the linear actuators are able to be manual or electric and are able to be used to level the base 2B and upper 4B frame respective to the load on the upper frame 4B and/or with respect to an uneven surface on which the frame is placed.

Simultaneous movement of the pistons 38 from the modules 8B, 8D and/or of the pistons 72 from the super knuckles 10B and 10D at a consistent speed enables the frame to be lifted in a purely vertical motion.

The arrangement can be considered as two sub assemblies, the first sub assembly consisting of super knuckle 10B and linear module 8B; the second sub assembly consisting of super knuckle 10D and linear module 8D.

Each sub assembly is able to move in either of two opposite directions (resulting in linear extension or retraction) independently. The speed of motion can also be controlled independently for each sub assembly. Of course the sub assemblies can be operated simultaneously at the same or different speeds with respect to other sub assemblies.

Furthermore within a sub assembly, the linear section of the super knuckles 10B and 10D is able to move in either of two opposite directions independently of motion of the linear module 8B and 8D which are able to two opposite directions. The linear actuators of the super knuckles or linear modules can of course be operated simultaneously and at the same or different speeds with respect to each other.

Therefore if a first of the sub assemblies moves in a first direction at a first speed and the second of the sub assemblies is held stationary or moves in an opposite direction to the first and/or at a different speed to the first, the upper frame will tend to tilt. The degree of tilt can be adjusted by attention to the relative speeds and direction of movements of the sub assemblies.

Tilting of the upper frame is, however, resisted by the rotary sections of the super knuckles 10B and 10D. Rotary motion must be enabled to permit tilting. It will be understood, the super knuckles are self locking and as such any tendency the upper frame has to tilt has to be accompanied by activation of the rotary sections of knuckles 10B and 10D in a direction which facilitates the linear motion of the associated sub assembly.

It will be understood, if both sub assemblies move unrestricted at the same speed over the same distance in the same direction pure vertical lift of the upper frame is established. However, if either sub assembly stops or changes speed or direction relative to the other, there will be a tendency for the upper frame to tilt. In one such example, the upper frame will begin to pivot about the pivot connection 78D. Furthermore the upper frame will pivot about the axes of shafts 86B and 86D as the super knuckles 10B and 10D operate to rotate in a direction to facilitate the required direction of upper frame tilt.

It will be appreciated that the upper frame is able to move both linearly in two opposing directions as well as tilt in two opposing rotational directions at any point from any starting position of the frame and without any predetermined sequence of linear and rotational motion.

It will also be appreciated that the third and fourth sub assemblies consisting respectively of 10A and 8A, and 10C and 8C are also identifiable and each has the capacity to operate with respect to any one of the three other sub assemblies as described above. Thus tilting is not limited to just two axes, it can be achieved about four separate axes and simultaneously about more than one axis.

If all sub assemblies move at the same speed in the same direction pure vertical lift of the upper frame is established. If, for example, during movement in a first direction, the second and fourth sub assemblies stop and the first and third sub assemblies continue at matched speed the upper frame will desire to tilt in the first direction. As such the upper frame will both begin to pivot about the pivot connection 78D and desire to pivot about the point 86D and the respective pivot point for the modules 8C and 10C. Furthermore, the upper frame will pivot about the axis of shaft 78B and desire to pivot about the point 86B and the respective pivot point of the rotary section of the super knuckle 10A and the linear module 8A and as the super knuckles 10A and 10B activate and rotate in the second direction (opposite to the first direction) for example allowing rotation about the point 86B and as the super knuckles 10C and 10D activate and rotate in the first or second direction for example allowing rotation about point 86D the upper frame will pivot as described.

As such it will be appreciated that the at least one upper frame is able to both move linearly in the first and/or second as well as tilt in the first or second direction without any sequence and at any point during any movement. This allows the at least one upper frame to vertically raise and/or lower and/or tilt independently or simultaneously with at least one sub assembly moving faster or slower or not moving at all by comparison to at least one other sub assembly. It will be further appreciated that each super knuckle 10A, 10B, 10C and 10D and their respective linear modules 8A, 8B, 8C and 8D has the ability to move independently or at the same speed as the others and as such the upper frame is able to tilt in third and fourth directions and consequently, the upper frame is able to pitch and roll as well as produce pure vertical motion.

It will be appreciated that additional super knuckles may be located in the upper frame at any orientation. It will be further appreciated that the linear modules 8A, 8B, 8C and 8D are able to be substituted with super knuckles 10 in any suitable orientation.

FIG. 5 shows a second embodiment of a self locking articulated frame 100 in accordance with the invention. The figure shows a plan view of the frame it shares very many features in common with the first embodiment and these are identified using the same reference numeral as used previously in the description relating to FIG. 1. It will be appreciated that where the functions and features are the same as for the previous embodiment, no further description will be given here.

As can be seen, the frame consists of the lower frames 2A and 2B, upper frames 4A and 4B and connection points for a backrest, a leg rest or a seat. Connection points 12A, 12B, 14A, 14B, 16A and 16B can incorporate at least one linear actuator and/or at least one rotary actuator which can to be attached, integrated or encapsulated into the frame.

The upper frame 4A, 4B features the super knuckles 10A, 10B, 10C and 10D and wheels 6A, 6B, 6C and 6D.

The second embodiment differs from the first embodiment in having a different vertical lift mechanism. Linear lift elements 102A, 1028, 104A and 104B are located in the base frame 2A, 2B and the upper frame 4A, 4B in the same manner as the modules 8A, 8B, 8C and 8D are located in the first embodiment.

The linear lift elements 102B, 104B and a gearbox 108 mesh with a length change transmission 106 which is arranged orthogonally to the lift elements 102A, 104A and 102B, 104B. The length of the transmission 106 is adjustable. In this example (but not essentially) the modules 102A, 102B, 104A and 104B and the gearbox 108 are each connected to the length change transmission 106 by a meshed relationship incorporating bevel gears. The lift mechanism in this embodiment is manually operated.

The gearbox 108 features a connection point for a handle (not shown) and where a handle is attached to the connection point and rotated, the applied load is transmitted to the lift elements 102A, 102B, 104A and 104B through the gearbox and to the lift elements 102A, 102B, 104A and 104B by the length change transmission 106.

A linear actuator (not shown) is operable to adjust the separation between the base 2A, 2B and upper frame 4A, 4B. As the transmission 106 is length adjustable independently of its connection with the frame base 2A and 2B and gearbox 108, the transmission 106 simply adjusts to accommodate the change in separation between the base 2A, 2B and upper frame 4A, 4B with no loss of connection to the modules 102A, 102B, 104A and 104B or the gearbox 108.

FIG. 6 shows a linear actuator module 104 suitable for use as a linear lift element 104A and 104B in the embodiment of FIG. 5. The module 104 is substantially similar to that referenced 8 in FIG. 2. As previously described, module 8 is operated by a motor; on the contrary module 104 is manually operated. Additional components of module will now be described.

The module 104 has a manual drive shaft with a bevel gear 118 external to the module. The gear 118 is connected to a second gear 110 via the drive shaft. The second gear 110 meshes with a third gear 112 which is integral with or attached to a leadscrew 114. The configuration is such that rotation of the gear 118 in turn rotates the gear 110 which rotates the gear 112 and consequently the leadscrew 114. The rotating leadscrew 114 meshes with piston 116 which is prevented from rotational motion and so traverses linearly along the axis of the leadscrew 114 in either one of two opposite directions determined by the direction of rotation of the gear 118.

FIG. 7 shows a linear actuator module 102 suitable for use as a linear lift element 102A and 102B in the embodiment of FIG. 5. The module 102 is substantially similar to that referenced 8 in FIGS. 2 and 104 referenced in FIG. 6. As previously described, module 8 is operated by a motor; on the contrary module 102 is manually operated. Additional components of the module will now be described.

A bevel gear 128 is integrated or attached to a drive shaft 130 terminating in a second bevel gear 132. The second bevel gear 132 meshes with a third bevel gear 138 carried on a shaft which extends orthogonally to shaft 130. The third bevel gear 138 meshes with a fourth bevel gear 134 of a drive shaft 136 which terminates in a fifth bevel gear 126 which in turn meshes with a sixth bevel gear 124. The bevel gear 124 is attached or integral with the leadscrew 122 where the leadscrew 122 to which is screw threaded a piston 120. The piston 120 is prevented from rotating with the leadscrew 122.

When the first gear 128 is rotated, this rotates the second gear 132 which in turn causes rotation of third and fourth gears 138 and 134, the latter rotates the fifth gear 124 which rotates the leadscrew 122 and the piston 120 which is prevented from rotational motion traverses linearly along the axis of the leadscrew 122 in either one of two opposite directions determined by the direction of rotation of the gear 128.

The third gear 138 allows the modules 102A and 102B to move linearly in the same direction as the modules 104A and 104B (see FIG. 6) from the same rotational direction input from the transmission 106 and subsequently the input from the gearbox 108.

FIG. 8 shows the length change transmission 106 in more detail. The transmission 106 is shown without an outer case, however it will be appreciated that an outer case would desirably be present in practical use. The transmission 106 comprises a first bevel gear 140 which is attached or integral with a first section of a split hollow shaft 146. The second section of the split hollow shaft 150 terminates in a second bevel gear 164. The hollow shaft 146, 150 incorporates a longitudinal slot 142, 162 in parallel with and passing through the axis of the shaft 146, 150 presenting a slot opening on two sides of the shaft 146, 150. A central shaft 148 is slidably mounted inside the hollow split shaft 146, 150 and shares its axis. Telescopic movement of each hollow split shaft section relative to the central shaft 148 is possible allowing independent length adjustment of the transmission 106. The central shaft 148 is provided with radially outwardly extending protrusions 144 and 160. Conveniently additional protrusions (not shown) are included on the opposite side of the central shaft 148 directly opposite the protrusions 144 and 160. Each protrusion engages in a slot 142, 162.

The configuration provides that when the bevel gear 164 is rotated, the shaft 150 rotates and the protrusion 160 engages the slot 162 causing rotation of the central shaft 148, the protrusion 144 engages the slot 142 and rotates with the central shaft 148. Consequently, the hollow split shaft portion 146 is caused to rotate and with it, the bevel gear 140.

FIG. 9 shows a gearbox 108 suitable for use as the gearbox referred to in the already described embodiments. The gearbox 108 is encased in a casing 170. Broadly, it comprises a plurality of gears held in the casing by bearing arrangements to ensure low friction rotation of components. A drive shaft 174 is configured to connect to a handle optionally with an intermediate, additional gearing arrangement. The drive shaft 174 features a bevel gear 168 which meshes with a transmission gear 164 (for example that described with the same reference numeral in FIG. 8) either directly or via one or more additional gears in a chain. As previously described, gear 164 terminates a shaft 150 such that rotation of the drive shaft 174 via a plurality of gears results in rotation of the transmission shaft 150.

As has been described in relation to FIG. 5, the transmission gear 164 meshes with an orthogonally aligned gear referenced 172 in the Figure. In an assembled modular system, gear 172 equates to gears 118 and 128 of FIGS. 6 and 7 respectively where they are meshed with the gear 164 of the transmission shaft. Therefore the rotation of the gear 168 via the drive shaft 174 rotates the gears 118 and 128 of the modules 102B and 1046, therefore the rotation of the drive shaft 174 via a plurality of gears causes linear extension or retraction of pistons 120 and 116 (as seen in FIGS. 6 and 7) dependent on the direction of rotation of the gear 168.

It will be appreciated that in such an assembly, the transmission 106 as referenced with respect to FIG. 5 may also be configured to drive the pistons 120 and 116 of the modules 102A and 104A shown in FIGS. 6 and 7 via the meshed relationship the gear 140 from FIG. 8 has with both the manual linear modules 102A and 104A. Therefore the rotation of the drive shaft 174 via a plurality of gears will move the pistons 120 and 116 of both the linear lift elements 102A, 104A in either of two opposite directions. And as such the rotation of the drive shaft 174 via a plurality of gears will move the pistons 120 and 116 of the modules 102A, 102B, 104A and 1046 in either of two opposite directions dependent on the direction of rotation of the shaft 174 and subsequently gear 168.

FIG. 10 shows a cross bar 105. The bar 105 encapsulates a linear actuator which may be of any of a number of configurations and is optionally manually or electrically operated. In the preferred embodiment shown, the linear actuator is electrically operated. A preferred configuration for the linear actuator is described.

The linear actuator has a casing 192 containing a motor 194 which is permanently or removably attached to a leadscrew collar section 190. The collar section 190 is supported by a bearing 188 and is attached and or integral with the leadscrew which has a threaded section 182. The leadscrew threaded section 182 is meshed with a piston 176. The piston 176 has at least one protrusion 186 which is slidably engaged in a channel 184 in a housing collar 178 so as to prevent the piston from rotating with the leadscrew.

The piston 176 is held at least partially in the collar 178 by a bearing 180. The bearing also has a channel that is alignable with the channel 184 such that the piston does not rotate when in operation.

The motor 194 can rotate in two opposing directions and in turn can cause the leadscrew to rotate in two opposite directions. The configuration provides that rotation of the leadscrew results in linear travel of the piston 176 along axis of the leadscrew. This linear travel may be in either of two opposite directions determined by the direction of rotation of the motor 194. Each end of the bar terminates in a connecting component 198 (of the casing) and 196 (of the piston) which may be permanently or detachably fixed or form an integral part of the casing or piston. In an assembled end product, the components 198 and 196 are also fixed to the frame 2A and 2B (of FIG. 5) respectively such that the movement of the piston adjusts the separation between the frames.

1. An articulating frame comprising parallel aligned base frame elements in a first plane adjustably connected to parallel aligned upper frame elements in a second plane, parallel to the first plane, the adjustable connection between any pair of connected base frame and upper frame elements comprising one or more knuckles each knuckle being capable of a combination of rotational and linear movement and operable independently of the others to provide both linear and rotational repositioning of a frame element relative to the other of the connected pair at the point of connection.

2. An articulating frame as claimed in claim 1, wherein the knuckle is serially linked to a linear actuator capable independently of adjusting the separation of the connected pair of frame elements.

3. An articulating frame as claimed in claim 2, wherein the linkage between the knuckle and linear actuator comprise a multi axis joint or rose type bearing.

4. (canceled)

5. An articulating frame as claimed in claim 1, wherein the knuckle comprises; a rotary actuator arranged to rotate a leadscrew, an internally threaded saddle meshing with the leadscrew and having a toothed section meshing with a first gear mounted on a first shaft aligned orthogonally to the leadscrew, a second gear mounted on a second shaft aligned in parallel with the first shaft, the second gear meshing with the first gear, a casing rotatably mounted relative to the axis of the second shaft, the casing enclosing a linear actuator, the arrangement being configured such that on operation of the rotary actuator, the angular separation of the axis of the linear actuator relative to a plane which includes the axes of both the first and second shaft is adjusted.

6. An articulating frame as claimed in claim 5, wherein an end of the casing distal to the shafts is provided with an attachment means for attaching to other components.

7. An articulating frame as claimed in claim 6, wherein the attachment means comprises a multi-axis bearing.

8. An articulating frame as claimed in claim 1, wherein the linear actuators have the following configuration; a motor configured to drive a first gear in two opposite directions which first gear in turn meshes with a second gear, the second gear operably coupled to a leadscrew such that rotation of the first gear results in rotation of the leadscrew in a direction determined by the direction of rotation of the first gear, the leadscrew rotatably mounted in a fixed axial orientation, a piston which is internally threaded and slidably engages the leadscrew thread and means for restricting rotational movement of the piston about the leadscrew axis whereby to force the piston to travel linearly along the axis of the leadscrew when the leadscrew rotates, the linear travel being in either of two opposite directions determined by the direction of rotation of the leadscrew.

9. An articulating frame as claimed in claim 8, wherein the means for restricting rotational movement comprises a cylindrical sleeve sharing a common axis with the leadscrew and piston and maintained in a fixed rotational position with respect to the axis, the piston including one or more radially outwardly extending protrusions which engage in a longitudinal slot provided in the cylindrical sleeve.

10. An articulating frame as claimed in claim 8, wherein an end of the piston distal to the second gear is provided with an attachment means for attaching to other components.

11. An articulating frame as claimed in claim 10, wherein the attachment means comprises a multi-axis bearing.

12. An articulating frame as claimed in claim 5, wherein the shafts of the knuckle extend beyond the knuckle to incorporate additional shaft mounted gears and the shaft mounted gears are operably connected to other gear driven components in the frame.

13. An articulating frame as claimed in claim 1, wherein the frame includes a length change mechanism configured for adjusting the separation between elements along an axis substantially perpendicular to the first and second plane.

14. An articulating frame as claimed in claim 13, wherein the length change mechanism comprises a length change transmission including a first bevel gear attached to or integral with a first section of a split hollow shaft, a second section of the split hollow shaft terminating in a second bevel gear, the split hollow shaft incorporating a longitudinal slot in parallel with the axis of the shaft, a central shaft slidably mounted inside the hollow split shaft sharing the axis of the split shaft the central shaft having one or more radially outwardly extending protrusions which engage in the slot.

15. An articulating frame as claimed in claim 14, wherein the slot extends through to the opposite side of the split hollow shaft and the central shaft includes protrusions engaging with the slot on both sides of the axis.

16. An articulating frame as claimed in claim 14, wherein the bevelled gears operably connect a drive means to a lifting mechanism which lifting mechanism comprise the one or more linear actuators, optionally the drive means comprises a gear which can be manually operated by applying leverage to an associated handle.

17. (canceled)

18. An articulating frame as claimed in claim 1, wherein the base frame elements incorporate an additional height adjustment mechanism.

19. An articulating frame as claimed in claim 1, wherein the base frame elements incorporate a castor, optionally the castor incorporates a lock to prevent unwanted rolling.

20. (canceled)

21. An articulating frame as claimed in claim 1, further comprising a cross bar configured for adjusting the separation between elements along an axis substantially perpendicular to the first and second plane, the cross bar encapsulating a linear actuator having a casing containing a motor configured to rotate in two opposite directions and operably connected to a leadscrew, the leadscrew threaded section meshed with an internal thread of a piston the piston being constrained from rotating with the leadscrew but free to move linearly along the leadscrew axis in either of two opposite directions dictated by the direction of rotation of the motor, optionally each end of the bar terminates in a connecting component for connecting to a frame element in each of the first and second planes.

22. (canceled)

23. An articulating frame as claimed in claim 1, wherein one or more of the actuators is driven by a gear box, the gear box including a drive shaft configured to operably connect with a handle, the drive shaft featuring a bevel gear which bevel gear operably engages with a transmission gear which terminates a transmission shaft such that rotation of the drive shaft results in rotation of the transmission shaft, the transmission gear meshing with an orthogonally aligned gear which gear operably connects with a drive gear of the actuator.

24. An articulating frame as claimed in claim 23, wherein the gears are rotatably mounted in a casing, the casing including sealed exit apertures through which the shafts exit, optionally the gears are operably connected via additional intermediate gears or chains of gears.

25. (canceled)

26. An articulated frame as claimed in claim 1, wherein at least one or more additional rotary and/or linear actuators or gearboxes are attached, integrated or encapsulated to facilitate the connection of a seat and/or backrest and/or leg rest

27. An articulated frame as claimed in claim 1, wherein at least one or more rotary and/or linear actuators or gearboxes are able to be connected to the frame such that data and or power is able to pass between the said actuators and/or gearbox and the frame.
